(19) United States
(12) Patent Application Publication
(10) Pub. No.: US 2014/0204936 A1
(43) Pub. Date: Jul. 24, 2014

(54) TRANSMISSION DEVICE, RECEPTION DEVICE, INFORMATION PROCESSING SYSTEM,CONTROL METHOD AND COMMUNICATION METHOD

(71) Applicant: Canon Kabushiki Kaisha, Tokyo (JP)

(72) Inventor: Daisuke Shiraishi, Tokyo (JP)

(73) Assignee: Canon Kabushiki Kaisha, Tokyo (JP)

(21) Appl. No.: 14/153,806

(22) Filed: Jan. 13, 2014

(30) Foreign Application Priority Data
Jan. 18, 2013 (JP) 2013-007505

(51) Int. Cl. H04L 12/933

(52) U.S. Cl. CPC H04L 49/15
USPC 370/366

(57) ABSTRACT

A data division unit of a serial transmission device divides transfer data to generate a plurality of divided data, a plurality of parallel-to-serial conversion units converts the divided data into serial data according to timing control provided by a transmission control unit to transmit the serial data to a plurality of data signal lines connected to the plurality of parallel-to-serial conversion units, a plurality of serial-to-parallel conversion units of a serial reception device receives the serial data from the data signal lines connected thereto to convert the serial data into parallel data, and a data restoration unit combines the parallel data, which are converted by the plurality of serial-to-parallel conversion units, to restore the transfer data in an order of completion of the conversion.

### BACKGROUND OF THE INVENTION

1. Field of the Invention

The present invention relates to a transmission device, a reception device, an information processing system, a control method and a communication method, and relates to a data transfer technique between devices.

2. Description of the Related Art

The integration degree and the processing performance in integrated circuits have been largely improved. The amount of data exchanged between integrated circuits has also increased. Thus, the data transfer band is desired to be increased. The data transfer band can be increased by transferring data in parallel by a parallel transfer method. However, the number of terminals in integrated circuits consequently increases, thus causing cost to increase and adjustment of skew among data signal lines to become difficult. Nowadays, a high speed serial-transfer method is increasingly employed for transferring data between integrated circuits. To increase the data transfer band in the serial-transfer method, it is necessary to increase the transfer speed or to transfer serial data in parallel without increasing the transfer speed. However, when serial data is transferred in parallel, the skew among data signal lines has to be precisely adjusted with an increase of the transfer speed.

Japanese Patent Application Laid-Open No. 2009-65508 discusses a reception device that performs a high speed serial data transfer. In the reception device, terminal arrangement on an integrated circuit can be flexibly changed by switching of connection between an internal circuit and input terminals for inputting a clock signal and serial data and connection of output destinations in an internal circuit. With this, wiring restrictions on a circuit board to be mounted are eased, and equal-length wiring of data signal lines can be achieved easily. Also in the case where equal-length wiring is impossible due to little space for bypassing data signal lines because a high density mounting is required on a circuit board, the skew among data signal lines can be adjusted by a circuit for delaying the data provided to each data signal lines.

In the technique discussed in Japanese Patent Application Laid-Open No. 2009-65508, switching of connection corresponding to the changes of terminal arrangement has to be completed before starting serial-transfer. Therefore, the reception device requires a central processing unit (CPU) for controlling a setting of the connection corresponding to the changes of the terminal arrangement and additional terminals, resulting in an increase of cost. Also, when the circuit for delaying the data is provided to each of the data signal lines, the cost of devices for performing serial communication is increased.

### SUMMARY OF THE INVENTION

According to an aspect of the present invention, a transmission device having a plurality of data output terminals includes a data division unit configured to divide transfer data to be transmitted to generate a plurality of divided data, a plurality of first conversion units each connected to a respective one of the plurality of data output terminals and each configured to convert the divided data into serial data and to output the serial data to the corresponding data output terminal, and a transmission control unit configured to vary a transmission start timing when the plurality of first conversion units transmits the serial data from the plurality of data output terminals so that data that is obtained by combining the serial data in an order that the plurality of the serial data is received at a receiving side is identical to the transfer data.

Further features of the present invention will become apparent from the following description of exemplary embodiments with reference to the attached drawings.

### BRIEF DESCRIPTION OF THE DRAWINGS

FIG. 1 illustrates an example of a configuration of an information processing system according to an exemplary embodiment of the present invention.

FIG. 2 illustrates an example of a configuration between serial communication devices according to the exemplary embodiment.

FIG. 3 illustrates an example of a configuration of a clock signal line and data signal lines according to the exemplary embodiment.

FIG. 4 illustrates a packet transfer by a serial communication according to the exemplary embodiment.

FIG. 5 illustrates an example of a configuration of a serial transmission device according to the exemplary embodiment.

FIG. 6 illustrates an example of a configuration of a serial reception device according to the exemplary embodiment.

FIG. 7 is a waveform diagram illustrating an example of a timing signal and a packet transfer according to the exemplary embodiment.

### DESCRIPTION OF THE EMBODIMENTS

Various exemplary embodiments, features, and aspects of the present invention will be described in detail below with reference to the drawings.

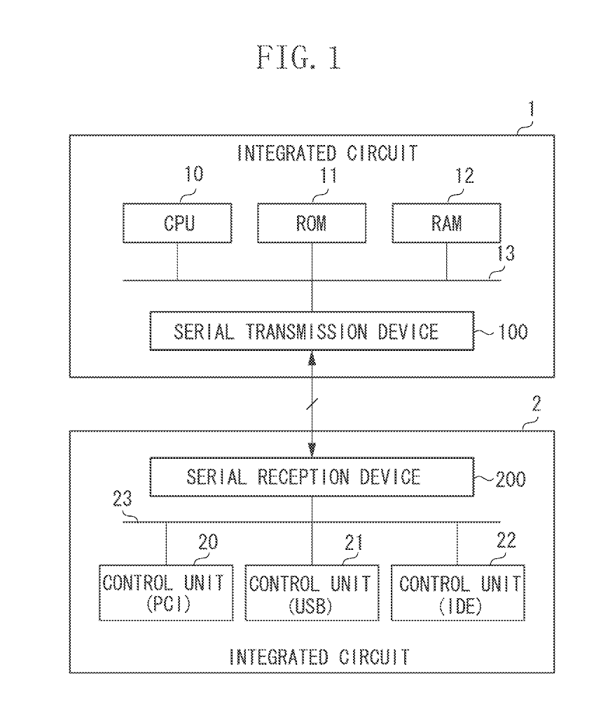

FIG. 1 is a block diagram illustrating an example of a configuration of an information processing system including serial communication devices according to an exemplary embodiment of the present invention. FIG. 1 illustrates, as an example, an information processing system including integrated circuits 1 and 2 each having a serial communication device mounted on a circuit board, and data transfer is performed between the integrated circuits 1 and 2 by a serial communication via a plurality of data signal lines formed on the circuit board.

A first integrated circuit 1 includes a central processing unit (CPU) 10, a read only memory (ROM) 11, a random access memory (RAM) 12, a first bus 13, and a serial transmission device 100. A second integrated circuit 2 includes control units 20, 21, and 22, a second bus 23, and a serial reception device 200.

In the first integrated circuit 1, the CPU 10, the ROM 11, and the RAM 12 are connected to the first bus 13. In the second integrated circuit 2, the control units 20, 21, and 22 are connected to the second bus 23. Further, the first bus 13 of the first integrated circuit 1 and the second bus 23 of the second integrated circuit 2 are connected each other via the serial transmission device 100, the plurality of data signal lines, and the serial reception device 200. This configuration is one of a typical configuration of, for example, a two-chip set configuration in a general-purpose computer.

The CPU 10 develops a program stored in the ROM 11 on the RAM 12, and reads the program from the RAM 12 to execute the same. Each of the control units 20, 21 and 22 controls various peripheral devices (not illustrated). For example, the control unit 20 controls peripheral devices compliant with peripheral components interconnect (PCI) standard, and the control unit 21 controls peripheral devices compliant with universal serial bus (USB) standard. The control unit 22, for example, controls peripheral devices connected by integrated drive electronics (IDE) method.

The serial transmission device 100 transfers data that are transmitted in accordance with a predetermined protocol to the serial reception device 200 via the CPU 10 or a direct memory access controller (DMAC, not illustrated) by a serial communication. The serial reception device 200 transfers the data obtained from the serial transmission device 100 to the control units 20, 21, and 22, which are connected the second bus 23, in accordance with a predetermined protocol (which may not be identical to the protocol of the first bus 13). The configuration of the information processing system including the serial communication devices according to the present exemplary embodiment is applicable not only to the configuration illustrated in FIG. 1 but also to a transmission device that transmits and receives transfer data between integrated circuits in serial communication mode.

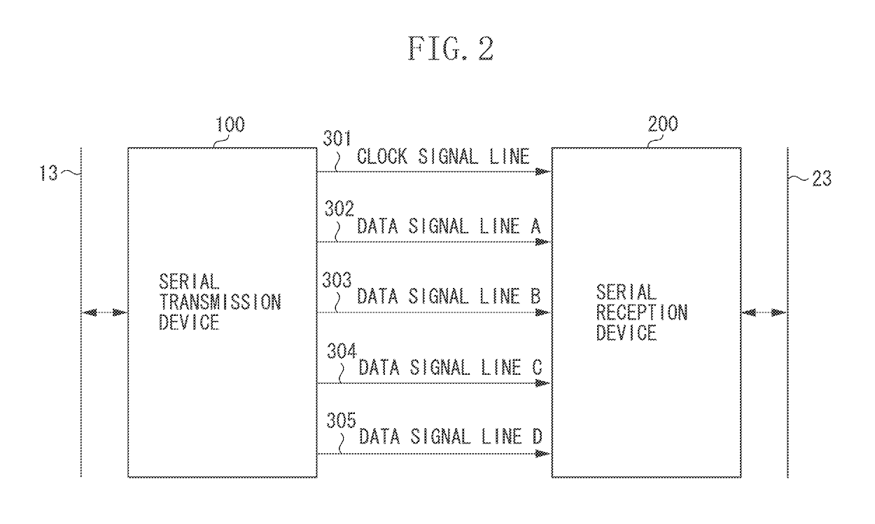

FIG. 2 illustrates an example of a configuration between the serial communication devices according to the present exemplary embodiment. FIG. 2 illustrates a configuration that performs serial communication in a source synchronous method between the serial transmission device 100 and the serial reception device 200. In the source synchronous method, to perform serial communication, a transmitting side transmits a clock signal separated from a data signal, and a receiving side samples the data signal using the received clock signal.

A clock output terminal of the serial transmission device 100 and a clock input terminal of the serial reception device 200 dealing with the serial communication are connected each other via a clock signal line 301. Also, data output terminals of the serial transmission device 100 and data input terminals of the serial reception device 200 dealing with the serial communication are connected via a data signal line A 302, a data signal line B 303, a data signal line C 304 and a data signal line D 305.

A clock signal is transmitted from the serial transmission device 100 to the serial reception device 200 via the clock signal line 301. A data signal (serial data) is transmitted from the serial transmission device 100 to the serial reception device 200 via each of the data signal lines A 302 to D 305. The data signal (serial data) transmitted via each of the data signal lines A 302 to D 305 is in synchronization with the clock signal transmitted via the clock signal line 301.

Each of the data signal lines A 302 to D 305 serves as one communication channel for transmitting and receiving data between the devices by the serial communication. That is, in the example illustrated in FIG. 2, four serial communication channels are formed between the serial transmission device 100 and the serial reception device 200, and each of the communication channels transmits the data signal (serial data).

FIG. 2 illustrates a case in which the source synchronous method is employed. However, an embedded clock method is also applicable to the present exemplary embodiment. In the embedded clock method, a clock element is embedded in a data signal to be transmitted. The receiving side extracts a clock element from the data signal and performs communication by sampling the data using the extracted clock element. When the embedded clock method is employed, the clock signal line 301 is not provided between the serial transmission device 100 and the serial reception device 200, and a clock element can be embedded in each data signal transmitted via the data signal lines A 302 to D 305.

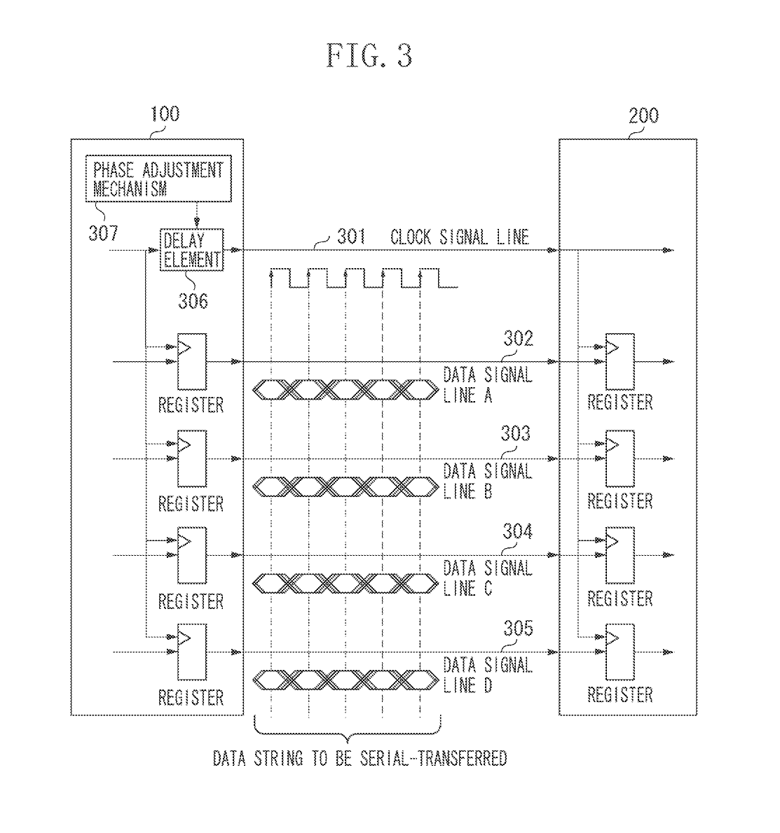

FIG. 3 illustrates an example of a configuration of the clock signal line 301 and the data signal lines A 302 to D 305 according to the present exemplary embodiment. Here, the configuration of the clock signal line 301 and the data signal lines A 302 to D 305 according to the present exemplary embodiment is described with an example of a center alignment method in which a rising edge of the clock signal is adjusted to position at a midpoint of interval between a transition and the next transition of the data signals. The method according to the present exemplary embodiment is not limited to the example illustrated in FIG. 3, but an edge alignment method is also applicable in a method of which the rising edge of a clock signal is positioned at a time of transition point of the data signals.

Recently, since periods of clock signals are getting shorter due to an increase in operation speed of integrated circuits, design margin is getting harder to secure due to an influence of wirings on printed circuit boards and an influence of variation of processing within integrated circuits. Therefore, the serial transmission device 100 illustrated in FIG. 3 includes a delay element 306 for delaying the clock signal and a phase adjustment mechanism 307 that provides an instruction to the delay element 306 to adjust a phase between the clock signal and the data signals. After checking the connection between the devices, the delay element 306 and the phase adjustment mechanism 307 adjust the delay amount of the clock signal so that the rising edge of the clock signal is positioned at the midpoint of the interval between a transition and the next transition of the data signals.

The method according to the present exemplary embodiment is applicable to a case in which the data signals are delayed to adjust the phases of the clock signal and the data signals. FIG. 3 illustrates a single data rate (SDR) method as an example in which the rising edge of the clock signal is used. A double data rate (DDR) method in which a rising edge and a falling edge of the clock signal are used is also applicable.

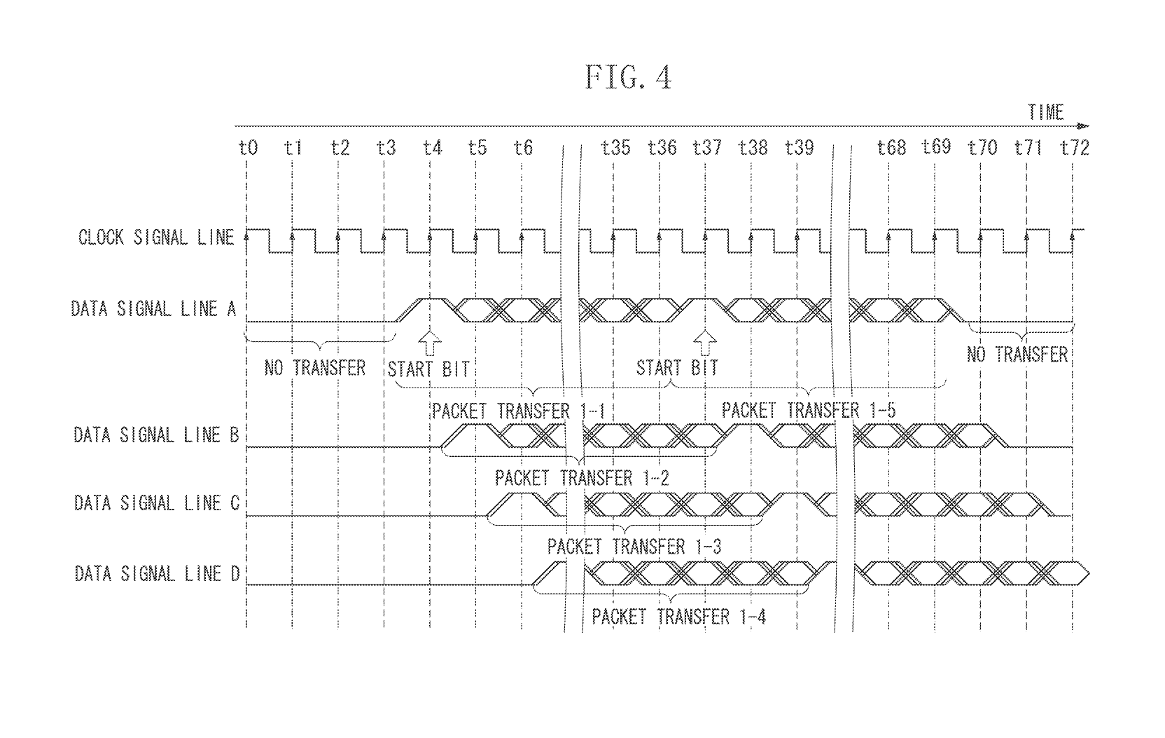

FIG. 4 illustrates a packet transfer by the serial communication according to the present exemplary embodiment. The serial communication according to the present exemplary embodiment is described as an example of a case that a packet to be transmitted is divided into units of 32 bits, and the divided data of 32-bit is serially transferred in parallel through four data signal lines A 302 to 305 D.

For example, in the data signal line A 302, a value of the data signal is “0” in a period of time from t0 to time t3. With this, both of the serial transmission device 100 and the serial reception device 200 recognize that no data is transferred via the data signal line A. At a period of time t4, the serial transmission device 100 sets the value of the data signal in the data signal line A to “1” as a start bit indicating the transfer start, then both devices recognize the transfer start of the divided data. In the following period of 32 cycles (from time t5 to time t36), the divided data is transferred by the serial transfer method at the data signal line A.

The divided data are transferred via the data signal line B 303, the data signal line C 304 and the data signal line D 305 in parallel to the data signal line A 302 by the serial transfer method in a similar manner as performed at the data signal line A 302. After completing the transfer of a first divided data, the value of the data signal in the data signal line A 302 is subsequently set to “1” at a point of time t37 as the start bit, and the transfer of the next divided data is performed (time t38 to time t69). After completing the transfer of the divided data to be transmitted, the value of the data signal of the data signal line A 302 is set to “0”, both devices recognize no data is transferred via the data signal line A 302.

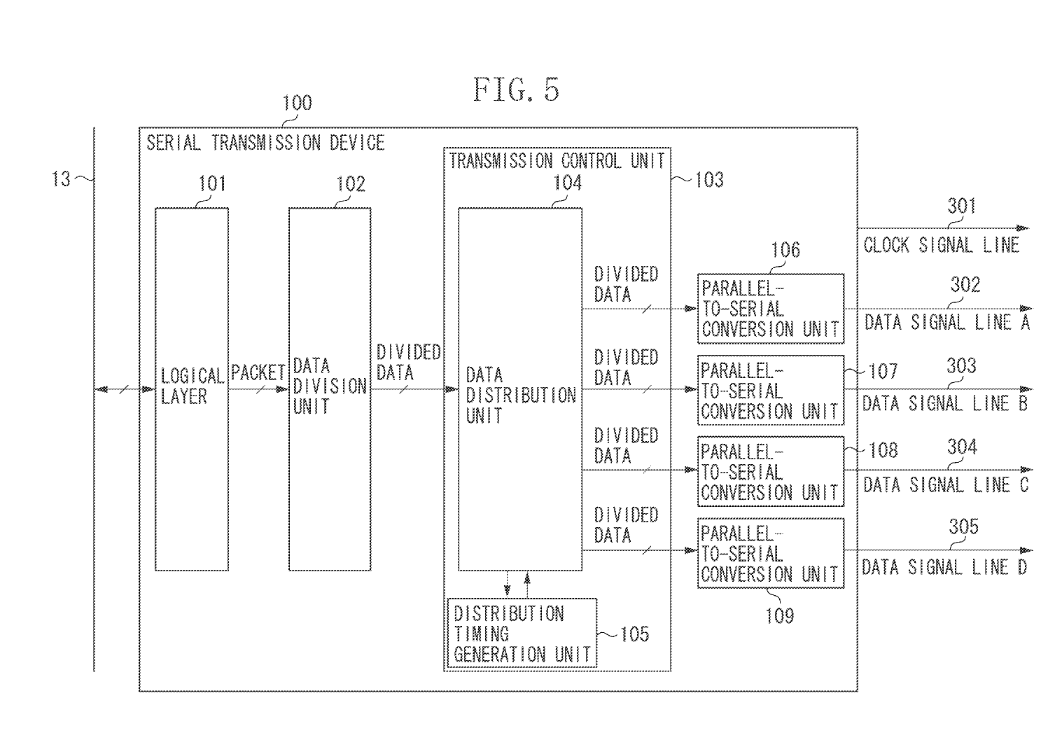

FIG. 5 illustrates an example of a configuration of the serial transmission device 100 according to the present exemplary embodiment. A logical layer 101 generates a packet from transfer data obtained from the first bus 13. A data division unit 102 divides the packet received from the logical layer 101 into predetermined bit units to generate divided data. According to the present exemplary embodiment, the data division unit 102 divides the received packet into 32-bit units. When the number of bits of the packet is not a multiple number of 32, the last divided data is rounded up to 32 bits by adding dummy bits.

A transmission control unit 103 includes a data distribution unit 104 and a distribution timing generation unit 105. The data distribution unit 104 sequentially distributes the divided data received from the data division unit 102 to parallel-to-serial conversion units 106, 107, 108, and 109 according to a timing signal output by the distribution timing generation unit 105. In this example, the data distribution unit 104 distributes the divided data to the parallel-to-serial conversion units 106 to 109 in the following order from the parallel-to-serial conversion unit 106, the parallel-to-serial conversion unit 107, the parallel-to-serial conversion unit 108, the parallel-to-serial conversion unit 109, and then back to the parallel-to-serial conversion unit 106.

The parallel-to-serial conversion units 106 to 109 as an example of a first conversion unit are connected to the data signal lines A 302 to D 305 respectively. Each of the parallel-to-serial conversion units 106 to 109 converts the 32-bit divided data received from the data distribution unit 104 into serial data and adds the start bit to the serial data to transmit the resultant data to the data signal lines A 302 to D 305 connected thereto, respectively. According to the present exemplary embodiment, the timing to distribute the divided data from the data division unit 102 to each of the parallel-to-serial conversion units 106 to 109 is controlled thereby to vary the timing to start transmission of the serial data at each of the data signal lines A 302 to D 305.

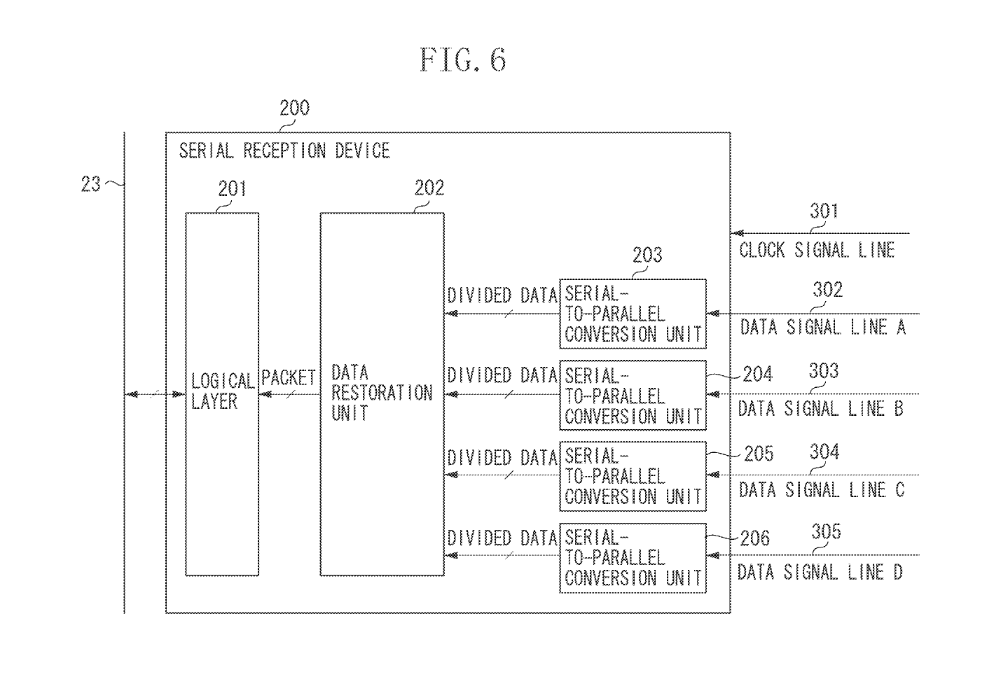

FIG. 6 illustrates an example of a configuration of the serial reception device 200 according to the present exemplary embodiment. Serial-to-parallel conversion units 203, 204, 205, and 206 as an example of a second conversion unit are connected to the data signal lines A 302 to D 305. Each of the serial-to-parallel conversion units 203 to 206 converts the serial data, which is received via the data signal lines A 302 to D 305 connected thereto, into 32-bit parallel data to generate divided data. A data restoration unit 202 combines the generated divided data in the order that the serial-to-parallel conversion units 203 to 206 have completed the generation of the divided data to restore the packet by assembling the divided data as continuous parallel data. A logical layer 201 analyzes the packet generated by the data restoration unit 202 and transmits the data to the second bus 23.

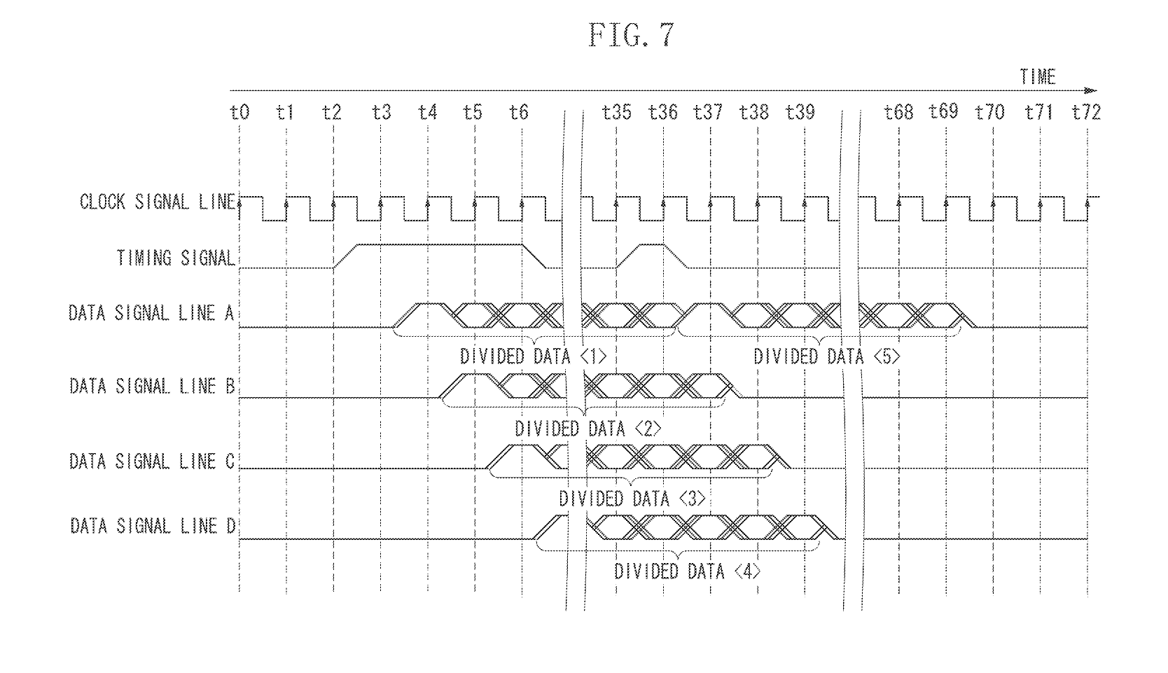

FIG. 7 is a waveform diagram illustrating an example of timing signals generated by the distribution timing generation unit 105 and packet transfer according to the present exemplary embodiment. FIG. 7 illustrates an example in which one packet is divided into five 32-bit units of divided data <1>, <2>, <3>, <4>, and <5>, and each piece of the divided data is serially transferred via the data signal lines A 302 to D 305. In the example illustrated in FIG. 7, the data division unit 102 of the serial transmission device 100 divides a packet into five pieces (divided data <1> to <5>) and successively output the pieces of data to the data distribution unit 104 from a point of time t2.

The distribution timing generation unit 105 of the serial transmission device 100 determines whether any divided data to be distributed by the data distribution unit 104 exists (condition 1), and whether the target parallel-to-serial conversion units 106 to 109 as distributing destinations are capable of receiving the divided data from the data distribution unit 104 (condition 2). Subsequently, the distribution timing generation unit 105 compares the order of the pieces of divided data, which are distributed by setting the timing signal to be valid, and the order of the pieces of divided data which are previously distributed. Then the distribution timing generation unit 105 determines whether the order in which the pieces of divided data are generated by the serial-to-parallel conversion units 203 to 206 of the serial reception device 200 is identical to the order of distribution (condition 3). When all of the three conditions (condition 1 to condition 3) are satisfied, the distribution timing generation unit 105 sets the timing signal for outputting the data to be valid (set the value to “1”).

At a point of time t3, there exists divided data (divided data <1>) to be distributed by the data distribution unit 104, and the parallel-to-serial conversion unit 106 as the distribution destination is transferring no serial data to the data signal line A. Therefore, the parallel-to-serial conversion unit 106 can receive the divided data from the data distribution unit 104. Also, at a point of time t2, since the target parallel-to-serial conversion unit 106 has been just after reset, and there exists no divided data distributed before the point of time t2, the order among the divided data is not required to be checked. That is, since the three conditions from the condition 1 to the condition 3 are satisfied, the distribution timing generation unit 105 sets the timing signal to be valid.

At a point of time t4, there exists the divided data <2> to be distributed by the data distribution unit 104, and the parallel-to-serial conversion unit 107 as the distribution destination is transferring no serial data to the data signal line B. Therefore, the parallel-to-serial conversion unit 107 can receive divided data from the data distribution unit 104. Also, even when the timing signal is set to be valid at the point of time t4 and the divided data <2> is distributed to the parallel-to-serial conversion unit 107, in the serial reception device 200, the serial-to-parallel conversion unit 204 can generate the divided data <2> after the serial-to-parallel conversion unit 203 generates the divided data <1>. Since the three conditions of the condition 1 to the condition 3 are satisfied, the distribution timing generation unit 105 sets the timing signal to be valid.

Likewise, at points of time t5 and t6, since the three conditions from the condition 1 to the condition 3 are satisfied, the distribution timing generation unit 105 sets the timing signal to be valid. In a period of time t7 through t35, since all of the parallel-to-serial conversion units 106 to 109 are transferring the serial data, and the parallel-to-serial conversion units 106 and 109 cannot receive any divided data from the data distribution unit 104, the timing signal cannot be set to be valid.

A point of time t36 when the transfer of the last serial data of the divided data <1> has been completed, the parallel-to-serial conversion unit 106 is able to receive next divided data from the data distribution unit 104. At the point of time t36, even when the timing signal is set to be valid, the serial-to-parallel conversion unit 203 can generate the divided data <5> after the serial-to-parallel conversion unit 206 has generated the divided data <4>. Therefore, since the three conditions from the condition 1 to the condition 3 are satisfied, the distribution timing generation unit 105 sets the timing signal to be valid.

The data distribution unit 104 distributes divided data received from the data division unit 102 to the parallel-to-serial conversion units 106 to 109 in order based on the timing signal output by the distribution timing generation unit 105. According to the present exemplary embodiment, the divided data are distributed in the following order from the parallel-to-serial conversion unit 106, the parallel-to-serial conversion unit 107, the parallel-to-serial conversion unit 108, the parallel-to-serial conversion unit 109, and then back to the parallel-to-serial conversion unit 106.

At the point of time t3, since the timing signal is valid, the data distribution unit 104 distributes the divided data <1> to the parallel-to-serial conversion unit 106. Likewise, the data distribution unit 104 distributes the divided data <2> to a parallel-to-serial conversion unit 107 at the point of time t4 when the timing signal is valid, the data distribution unit 104 distributes the divided data <3> to parallel-to-serial conversion unit 108 at a point of time t5, and the data distribution unit 104 distributes the divided data <4> to the parallel-to-serial conversion unit 109 at a point of time t6. Also, at the point of time t36 when the timing signal is valid, the data distribution unit 104 distributes the divided data <5> to the parallel-to-serial conversion unit 106.

When divided data is distributed from the data distribution unit 104, the parallel-to-serial conversion units 106 to 109 convert the divided data into serial data. Subsequently, each of the parallel-to-serial conversion units 106 to 109 adds a start bit to the converted serial data and transmits the resultant serial data to the connected data signal lines A 302 to D 305 from a following cycle after the divided data is distributed.

The serial-to-parallel conversion units 203 to 206 of the serial reception device 200 receives the serial data transmitted via the connected data signal lines A 302 to 305 D and convert the data into the parallel data to generate the divided data. At the point of time t36, the serial-to-parallel conversion unit 203 completes the generation of the divided data <1>. Likewise, the serial-to-parallel conversion unit 204 completes the generation of the divided data <2> at a point of time t37, the serial-to-parallel conversion unit 205 completes the generation of the divided data <3> at a point of time t38, and the serial-to-parallel conversion unit 206 completes the generation of the divided data <4> at a point of time t39. At a point of time t69, the serial-to-parallel conversion unit 203 completes the generation of the divided data <5>.

The data restoration unit 202 combines the divided data in the order that the serial-to-parallel conversion units 203 to 206 have completed the generation of the divided data and assembles the divided data as a continuous parallel data to restore the packet. According to the present exemplary embodiment, in the serial reception device 200, the timing of the transmission start sent from the serial transmission device 100 is controlled so that the generation of the divided data from the received serial data completes in an order identical to the arrangement order of the plurality of divided data in the transfer data. That is, the distribution timing generation unit 105 of the serial transmission device 100 ensures that the order of the pieces of divided data generated by the serial-to-parallel conversion units 203 to 206 of the serial reception device 200 is identical to the order of the pieces of divided data distributed by the data distribution unit 104. Therefore, the data restoration unit 202 assembles the pieces of divided data into a parallel data in the order of completion of the generation thereby correctly restore the packet in the serial reception device 200.

According to the present exemplary embodiment, the serial transmission device 100 controls the timing so that the order of the divided data is identical to the order of the divided data generated by the serial-to-parallel conversion units 203 to 206 of the serial reception device 200 to transmit serial data, which is converted from the divided data. Also, the serial reception device 200 combines the divided data generated by the serial-to-parallel conversion units 203 to 206 from the received serial data to restore the data in the order of the completion of generation. With this, in a serial communication using the plurality of data signal lines A 302 to D 305, the data output terminals of the serial transmission device 100 and the data input terminals of the serial reception device 200 can be desirably connected to each other to perform data transfer in the serial-transfer method. Therefore, the equal-length wiring of the data signal lines can be easily achieved on a circuit board without requiring complicated circuits or settings. Accordingly, the data transfer band can be increased at a low cost and a high speed data transfer can be achieved in a serial communication.

Here, it is assumed that the equal-length wiring is unfeasible due to mounting circumstances on a circuit board. For example, only the number of delay cycles of the data signal line C 304 illustrated in FIG. 2 is less than that of the other data signal lines by one cycle. In such case, the distribution timing generation unit 105 in the serial transmission device 100 sets the timing signal to be valid with an interval of one cycle after the data distribution unit 104 distributes the divided data to the parallel-to-serial conversion unit 107. Accordingly, the order of the divided data distributed by the data distribution unit 104 is identical to the order of the divided data generated by the serial-to-parallel conversion units 203 to 206. Thus, the serial communication in which transfer data can be properly restored can be performed. Even in the case as described above, each of the data signal lines requires no delay circuit or the like for adjusting a skew according to the present exemplary embodiment. Thus, a high speed serial communication can be achieved at a low cost.

The serial communication between integrated circuits according to the present exemplary embodiment is described above. However, the present invention is not limited to the above-described configuration but is applicable also to a serial communication among circuit blocks in an integrated circuit on a chip. Also, the present invention is applicable to a serial communication between integrated circuits located on the top and the bottom of a silicon substrate, which are connected via many pieces of through silicon via (TSV). For example, each of the serial transmission device 100 and the serial reception device 200 may be a separate lamination and one may be laminated on the other. A layer that performs a different function may be interposed between the serial transmission device 100 and the serial reception device 200, but in view of wiring delay, both are preferably located adjacent to each other.

The above-described exemplary embodiment has given a few examples of implementation of the present invention. Therefore, the present invention should not be understood in a limited technical scope. That is, the present invention can be implemented in a variety of configurations within a technical idea or major features thereof.

According to the present invention, the data transfer band can be increased with a simple configuration, and the data transfer can be performed in a high speed serial communication at a low cost.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the present invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-007505 filed Jan. 18, 2013, which is hereby incorporated by reference herein in its entirety.

What is claimed is:

1. A transmission device having a plurality of data output terminals, the transmission device comprising:
a data division unit configured to divide transfer data to be transmitted to generate a plurality of divided data;
a plurality of first conversion units each connected to a respective one of the plurality of data output terminals and each configured to convert the divided data into serial data and to output the serial data to the corresponding data output terminal; and
a transmission control unit configured to vary a transmission start timing when the plurality of first conversion units transmits the serial data from the plurality of data output terminals so that data that is obtained by combining the serial data in an order that the plurality of the serial data is received at a receiving side is identical to the transfer data.

2. The transmission device according to claim 1, wherein the transmission control unit varies the transmission start timing so that the conversion of the serial data into the divided data at the receiving side that receives and converts the serial data into the divided data is completed in an order identical to an arrangement order of the plurality of divided data in the transfer data.

3. The transmission device according to claim 1, wherein the transmission control unit comprises:
a data distribution unit configured to distribute the plurality of divided data generated by the data division unit to any of the plurality of first conversion units in order; and
a distribution timing generation unit configured to generate a timing when the data distribution unit distributes the divided data to the plurality of first conversion units,
wherein the distribution timing generation unit controls the timing to distribute the divided data to vary the transmission start timing.

4. The transmission device according to claim 1, wherein the data division unit divides the transfer data that is to be transmitted in predetermined units to generate the plurality of divided data.

5. A reception device having a plurality of data input terminals, the reception device comprising:
a plurality of second conversion units each connected to respective one of the plurality of data input terminals and each configured to receive serial data that has different transmission start timing from the corresponding data input terminal and to convert the received serial data into parallel data; and
a data restoration unit configured to restore transfer data by combining the parallel data converted by the plurality of second conversion units in an order of completion of the conversion.

6. An information processing system including a transmission device and a reception device, which are connected to each other via a plurality of data signal lines,
wherein the transmission device comprises:
a data division unit configured to divide transfer data that is to be transmitted to generate a plurality of divided data:
a plurality of first conversion units each connected to a respective one of the plurality of data output terminals and each configured to convert the divided data into serial data and to output the serial data to the corresponding data signal line; and
a transmission control unit configured to vary transmission start timing when the plurality of first conversion units transmits the serial data from the plurality of data signal lines so that data that is obtained by combining the serial data in an order that the plurality of the serial data is received at a receiving side is identical to the transfer data, and
wherein the reception device comprises:
a plurality of second conversion units each connected to a respective one of the plurality of data input terminals and each configured to receive the serial data and to convert the serial data into parallel data; and
a data restoration unit configured to restore transfer data by combining the parallel data converted by the plurality of second conversion units in an order of completion of the conversion.

7. The information processing system according to claim 7, wherein the data signal lines are through electrodes while the transmission device and the reception device are laminated on each other.

8. A control method for a transmission device having a plurality of data output terminals, the control method comprising:
dividing transfer data to be transmitted;
performing first conversion to convert the divided data into serial data and to output the serial data to the data output terminals; and
varying transmission start timing to transmit the serial data in the first conversion so that data obtained by combining the serial data in a received order at a receiving side is identical to the transfer data.

9. A control method for a reception device having a plurality of data input terminals, the control method comprising:
performing second conversion to receive serial data that has different transmission start timing from the data input terminals and to convert the received serial data into parallel data; and
combining the parallel data converted in the second conversion in an order of completion of the conversion.

10. A communication method between two communication devices being connected via a plurality of data signal lines, the communication method comprising:
generating a plurality of divided data by dividing transfer data to be transmitted;
performing first conversion to convert the divided data into serial data and to output each of the divided data to the corresponding data signal lines;
varying transmission start timing for each of the divided data when the serial data is transmitted in the first conversion so that data that is obtained by combining the serial data in an order that the plurality of the serial data is received at a receiving side is identical to the transfer data;
performing second conversion to receive the serial data from the data signal lines and to convert the serial data into parallel data; and
restoring the transfer data by combining the parallel data converted in the second conversion in an order of completion of the conversion.
